(19) United States
(12) Patent Application Publication
(10) Pub. No.: US 2022/0414901 A1
(43) Pub. Date: Dec. 29, 2022

(54) REAL-TIME DETECTION METHOD OF BLOCK MOTION BASED ON FEATURE POINT RECOGNITION

(71) Applicant: TIANJIN RESEARCH INSTITUTE FOR WATER TRANSPORT ENGINEERING, M.O.T, TIANJIN (CN)

(72) Inventors: Songgui CHEN, Tianjin (CN); Hanbao CHEN, Tianjin (CN); Huaqing ZHANG, Tianjin (CN); Linchun GAO, Tianjin (CN); Xu ZHAO, Tianjin (CN); Chuanqi HU, Tianjin (CN); Cheng PENG, Tianjin (CN); Yina WANG, Tianjin (CN); Jun MA, Tianjin (CN); Zhonghua TAN, Tianjin (CN); Yingni LUAN, Tianjin (CN)

(21) Appl. No.: 17/892,232

(22) Filed: Aug. 22, 2022

Related U.S. Application Data
(63) Continuation of application No. PCT/CN2022/074244, filed on Jan. 27, 2022.

(30) Foreign Application Priority Data
Mar. 31, 2021 (CN) 2021103523631

(51) Int. Cl. G06T 7/33; G06T 7/223; G06T 7/35

(52) U.S. Cl. CPC G06T 7/33; G06T 7/223; G06T 7/35

(57) ABSTRACT

Disclosed is a real-time detection method of a block motion based on a feature point recognition, including following steps: S1, calibrating a camera; S2, shooting digital images of a block on a surface of a breakwater by the camera, and sending the digital images to a digital signal processing system based on a field programmable gate array; S3, carrying out a feature point detection of the block in the images by the digital signal processing system; S4, carrying out a coordinate conversion after the feature point detection; S5, comparing position changes of the feature points of the block before and after a test, making a difference between coordinates of the two images before and after the test to obtain a change value of the feature points, and obtaining a displacement of the block; and S6, displaying displacement calculation results on a data processor.

### CROSS-REFERENCE TO RELATED APPLICATIONS

This application claims priority to Chinese Patent Application No. 202110352363.1, filed on Mar. 31, 2021, the contents of which are hereby incorporated by reference.

### TECHNICAL FIELD

The application belongs to the field of ocean engineering, and in particular to a real-time detection method of a block motion based on a feature point recognition.

### BACKGROUND

A damage of a breakwater is usually judged by a motion and a fracture of an armour block. Therefore, it is necessary to study a laboratory block motion detection device. Commonly used block motion detection methods include a visual inspection, close-up photography and photogrammetry from a fixed position. The visual inspection is useful for checking the specific damage. A number of broken blocks and moving blocks in each breakwater section may be checked visually, but this method takes times and is not suitable for checking the whole breakwater. The close-up photography only records visual inspection results, so the close-up photography is useful for checking details of local injuries. It is the most useful and cost-effective method in a breakwater inspection to make overlapping photos covering a whole water surface of the breakwater by the photogrammetry from the fixed position. It is a feasible method to analyze a state of the breakwater through images collected before and after a test. However, a detection and an extraction of targets in the images require high calculation requirements, so the above method may not be used in systems with a limited calculation ability. However, the above methods may only qualitatively analyze the motion and a displacement of the block, and do not achieve a quantitative measurement or a real-time measurement.

### SUMMARY

In view of this, the application proposes a real-time detection method of a block motion based on a feature point recognition to solve a problem that the existing detection method may only qualitatively analyze a motion and a displacement of a block, and may not realize a quantitative measurement and a real-time measurement.

In order to achieve an objective, a technical scheme of the application is realized as follows:

the real-time detection method of block motion based on the feature point recognition includes following steps:

S1, calibrating a camera;

S2, shooting digital images of a block on a surface of a breakwater by the camera, and sending the digital images to a digital signal processing system based on a field programmable gate array;

S3, carrying out a feature point detection of the block in the images by the digital signal processing system;

S4, carrying out a coordinate conversion after the feature point detection;

S5, comparing position changes of the feature points of the block before and after a test, making a difference between coordinates of the two images before and after the test to obtain a change value of the feature points, and obtaining a displacement of the block; and

S6, displaying displacement calculation results on a data processor.

In an embodiment, the feature point detection in the S3 includes the following steps:

S31, generating edge points of digital images by using a Hessian matrix, and setting each edge point in the digital images with the Hessian matrix;

S32, constructing a Gaussian pyramid by using the digital images;

S33, comparing a size of each pixel processed by the Hessian matrix with the size of the pixels in a three-dimensional neighborhood of the pixel; and if the pixel is a maximum value or a minimum value of the pixels in the neighborhood, reserving this pixel as a preliminary feature point;

S34, counting Harr wavelet features in the neighborhood of the feature point;

S35, generating feature point descriptors according to the Harr wavelet features;

S36: judging a matching degree of the two feature points by calculating a distance between the two feature points, and the shorter the distance between the two feature points, the higher the matching degree; and

S37: screening the feature points corresponding to each block, reserving the feature point with the highest matching degree to represent the block, and completing the feature point detection.

A method of generating the edge points of the digital images by using the Hessian matrix used in the S31 is as follows:

$$H ( f ( x , y ) ) = [ \begin{matrix}\frac{{\partial }^{2} f}{\partial {x}^{2}} & \frac{{\partial }^{2} f}{\partial x \partial y} \\ \frac{{\partial }^{2} f}{\partial x \partial y} & \frac{{\partial }^{2} f}{\partial {y}^{2}}\end{matrix} ] ,$$

where f(x,y) is a pixel value of each image;

a discriminant of the Hessian matrix is:

$$det ( H ) = \frac{{\partial }^{2}}{\partial {x}^{2}} \frac{{\partial }^{2}}{\partial {y}^{2}} - ( \frac{{\partial }^{2} f}{\partial x \partial y} ) ;$$

when the discriminant of the Hessian matrix gets a local maximum, judging that the current point is brighter or darker than other points in the surrounding neighborhood, and then this point is a position of the feature point.

In an embodiment, in a Gaussian pyramid construction in the S32, sizes of the images are unchanged, only the size and a scale of a Gaussian fuzzy template are changed.

In an embodiment, the steps of counting the Harr wavelet features in the neighborhood of the pixels in the S34 are as follows:

S341, taking one feature point as a center, calculating a sum of Haar wavelet responses of all the points in the neighborhood in a horizontal direction and a vertical direction;

S342, assigning Gaussian weight coefficients to Haar wavelet response values, making a response contribution near the feature point greater than the response contribution far from the feature point;

S343, adding the Haar wavelet responses in the neighborhood to form new vectors;

and

S344, traversing a whole area and selecting a direction of the longest vector as a main direction of the feature point.

In an embodiment, generating the feature point descriptors in the S35 is to take a 4*4 rectangular area block around the feature point along the main direction of the feature point, and count the Harr wavelet features of the pixels in each sub-area in the horizontal direction and the vertical direction; the Haar wavelet features include the sum of horizontal values, the sum of horizontal absolute values, the sum of vertical absolute values and the sum of vertical absolute values.

In an embodiment, a coordinate conversion method used in the S4 is as follows:

establishing an o₀uv pixel coordinate system, with o₀ as an origin of the pixel coordinate system, (u₀,v₀) as a pixel coordinate of a center of an image plane, establishing o₁xy as a physical coordinate system, with o₁ as the origin of the physical coordinate system;

$$u = \frac{x}{dx} + {u}_{0} ,$$

$$v = \frac{y}{dy} + {v}_{0} ,$$

where dx is a physical size of each pixel in a u-axis direction, and dy is the physical size of each pixel in a v-axis direction.

In an embodiment, a calibration of the camera in the S1 adopts a Zhang Zhengyou's calibration method.

Compared with the prior art, the application has following beneficial effects.

A real-time detection device for a laboratory block motion based on the feature point recognition proposed by the application adopts a remote-controlled digital camera to send gray pixels and a block motion measurement algorithm realized in the digital signal processing system based on the field programmable gate array to analyze the gray pixels to measure the motion of laboratory blocks. The block motion measurement algorithm constructs the Gaussian pyramid, and the sizes of the images in different groups are all the same; a difference is that template sizes of box filters used in different groups gradually increase, and the images of the same group in different layers use filters with the same size, but scale space factors of the filters gradually increase, so as to achieve a scale invariance; the block motion measurement algorithm rotates the image to the main direction before generating a feature descriptor, so as to ensure that the descriptor generated by one feature point uses information of the same image, realize a rotation invariance, and realize a better effect on a scale change when an illumination, a shadow and a focus are lost. Finally, the block motion measurement algorithm is implemented in the field programmable gate array, so that a requirement of the system for a computing power is greatly reduced, the displacement of the block in the image before and after the test is calculated in real time, and a response speed is fast. In addition, the detection device for the laboratory block motion has advantages of a low manufacturing cost, a convenient installation, a difficulty in damage and a low maintenance cost.

### BRIEF DESCRIPTION OF THE DRAWINGS

Drawings that form a part of the application are used to provide a further understanding of the application, and illustrative embodiments of the application and their descriptions are used to explain the application, without unduly limiting the application.

FIG. 1 is a flow chart of a real-time detection method of a block motion based on a feature point recognition according to an embodiment of the application.

FIG. 2 is a schematic diagram of a breakwater according to an embodiment of the application.

FIG. 3 is a flow chart of S3 according to an embodiment of the application.

FIG. 4 is a flow chart of S34 according to an embodiment of the application.

### DETAILED DESCRIPTION OF THE EMBODIMENTS

It should be noted that embodiments of the application and the features in the embodiments may be combined with each other without conflict.

In a description of the application, it should be understood that an orientation or position relationship indicated by terms “center”, “longitudinal”, “transverse”, “upper”, “lower”, “front”, “rear”, “left”, “right”, “vertical”, “horizontal”, “top”, “bottom”, “inner”, “outer” and so on is based on the orientation or position relationship shown in attached drawings, only for a convenience of describing the application and simplifying the description, rather than indicating or implying that a device or an element referred to must have a specific orientation, be constructed and operated in a specific orientation, it cannot be understood as a limitation of the application. In addition, the terms “first” and “second” are only used for descriptive objectives, and cannot be understood as indicating or implying a relative importance or implicitly indicating a number of indicated technical features. Therefore, the features defined as “first”, “second” and the like may explicitly or implicitly include one or more of these features. In the description of the application, unless otherwise stated, “a plurality” means two or more.

In the description of the application, it should be noted that unless otherwise specified and limited, the terms “installed”, “connected” and “connected” should be understood in a broad sense. For example, the terms mean that elements may be fixedly connected, detachably connected or integrally connected, may be mechanically connected or electrically connected, may be directly connected or indirectly connected through an intermediate medium, or may be an internal communication of two elements. For those of ordinary skill in the art, the specific meanings of the above terms in the application may be understood through specific situations.

Hereinafter, the application is described in detail with reference to drawings and the embodiments.

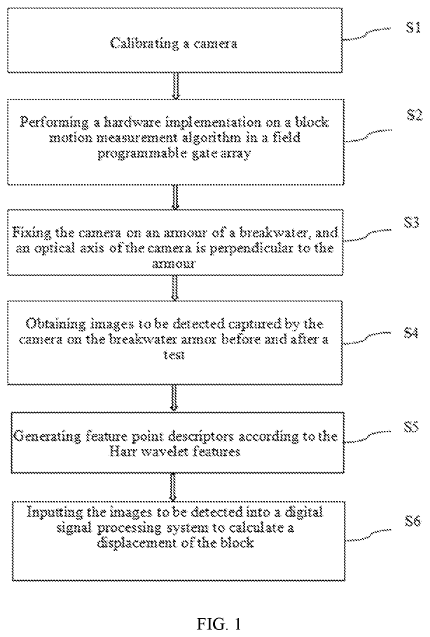

As shown in FIG. 1, a real-time detection method of a block 7 motion based on a feature point recognition includes following steps:

S1, calibrating a camera;

S2, shooting digital images of a block 7 on a surface of a breakwater 6 by the camera, and sending the digital images to a digital signal processing system based on a field programmable gate array;

S3, carrying out a feature point detection of the block 7 in the images by the digital signal processing system;

S4, carrying out a coordinate conversion after the feature point detection;

S5, comparing position changes of the feature points of the block 7 before and after a test, making a difference between coordinates of the two images before and after the test to obtain a change value of the feature points, and obtaining a displacement of the block 7; and

S6, displaying displacement calculation results on a data processor.

A digital camera is arranged above a water tank and perpendicular to a model armour, an image acquisition controller is directly connected with the digital camera to control continuous shootings of the images, and the digital signal processing system processes and analyzes the acquired images and transmits analysis results to the data processor.

The digital signal processing system is used to process the images in real time; the digital camera is configured to send gray pixels; the camera communicates with a digital signal processing by using but not limited to a USB bus; the image acquisition controller remotely controls the camera to shoot the continuous images without contacting the camera.

A field programmable gate array module includes a video acquisition module, an image storage module, a data processing module and an image display module.

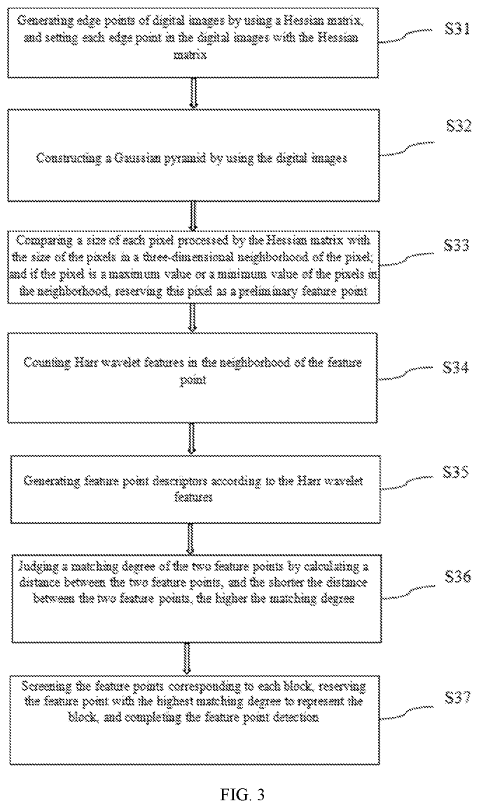

As shown in FIG. 3, the feature point detection in the S3 includes the following steps:

S31, generating edge points of digital images by using a Hessian matrix, and setting each edge point in the digital images with the Hessian matrix;

S32, constructing a Gaussian pyramid by using the digital images;

S33, comparing a size of each pixel processed by the Hessian matrix with the size of the pixels in a three-dimensional neighborhood of the pixel; and if the pixel is a maximum value or a minimum value of the pixels in the neighborhood, reserving this pixel as a preliminary feature point;

S34, counting Harr wavelet features in the neighborhood of the feature point;

S35, generating feature point descriptors according to the Harr wavelet features;

S36: judging a matching degree of the two feature points by calculating a distance between the two feature points, and the shorter the distance between the two feature points, the higher the matching degree; and

S37: screening the feature points corresponding to each block 7, reserving the feature point with the highest matching degree to represent the block 7, and completing the feature point detection.

A method of generating the edge points of the digital images by using the Hessian matrix used in the S31 is as follows:

$$H ( f ( x , y ) ) = [ \begin{matrix}\frac{{\partial }^{2} f}{\partial {x}^{2}} & \frac{{\partial }^{2} f}{\partial x \partial y} \\ \frac{{\partial }^{2} f}{\partial x \partial y} & \frac{{\partial }^{2} f}{\partial {y}^{2}}\end{matrix} ] ,$$

where f(x,y) is a pixel value of each image;

a discriminant of the Hessian matrix is:

$$det ( H ) = \frac{{\partial }^{2}}{\partial {x}^{2}} \frac{{\partial }^{2}}{\partial {y}^{2}} - ( \frac{{\partial }^{2} f}{\partial x \partial y} ) ;$$

when the discriminant of the Hessian matrix gets a local maximum, judging that the current point is brighter or darker than other points in the surrounding neighborhood, and then this point is a position of the feature point.

In a Gaussian pyramid construction in the S32, sizes of the images are unchanged, only the size and a scale of a Gaussian fuzzy template are changed.

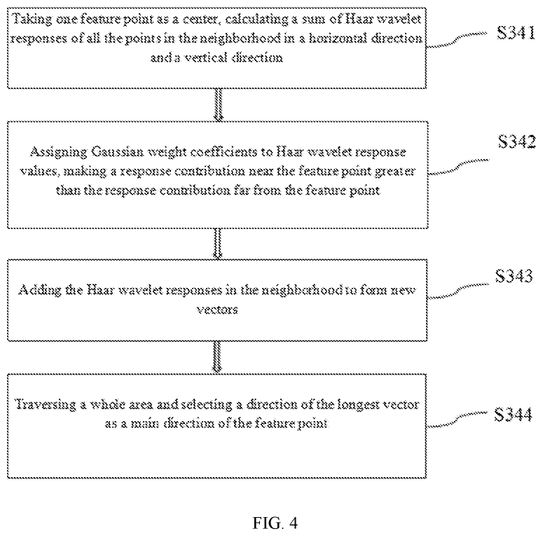

As shown in FIG. 4, the steps of counting the Harr wavelet features in the neighborhood of the pixels in the S34 are as follows:

S341, taking one feature point as a center, calculating a sum of Haar wavelet responses of all the points in the neighborhood in a horizontal direction and a vertical direction;

S342, assigning Gaussian weight coefficients to Haar wavelet response values, making a response contribution near the feature point greater than the response contribution far from the feature point;

S343, adding the Haar wavelet responses in the neighborhood to form new vectors; and

S344, traversing a whole area and selecting a direction of the longest vector as a main direction of the feature point.

Generating the feature point descriptors in the S35 is to take a 4*4 rectangular area block around the feature point along the main direction of the feature point, and count the Harr wavelet features of the pixels in each sub-area in the horizontal direction and the vertical direction; the Haar wavelet features include the sum of horizontal values, the sum of horizontal absolute values, the sum of vertical absolute values and the sum of vertical absolute values.

A coordinate conversion method used in the S4 is as follows:

establishing an o₀uv pixel coordinate system, with o₀ as an origin of the pixel coordinate system, (u₀, v₀) as a pixel coordinate of a center of an image plane, establishing o₁xy as a physical coordinate system, with o₁ as the origin of the physical coordinate system;

$$u = \frac{x}{dx} + {u}_{0} ,$$

$$v = \frac{y}{dy} + {v}_{0} ,$$

where dx is a physical size of each pixel in a u-axis direction, and dy is the physical size of each pixel in a v-axis direction.

In an embodiment, a calibration of the camera in the S1 adopts a Zhang Zhengyou's calibration method.

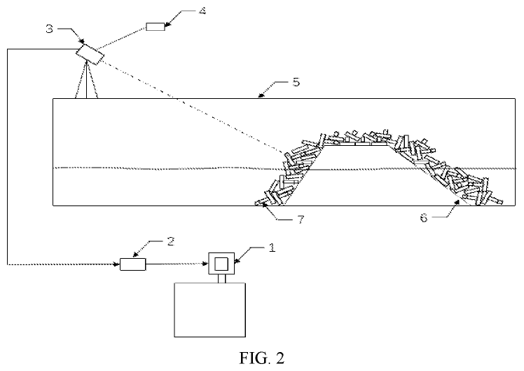

As shown in FIG. 2, when a water surface 5 is completely calm, the digital camera 3 is used to take the digital images of the breakwater 6 armour before and after the test under a remote control of the image acquisition controller 4, and then the gray pixels are transmitted to a digital signal processing system 2 based on the field programmable gate array; the feature point detection, the coordinate conversion and the displacement calculation of the block 7 in the images are carried out in the digital signal processing system 2, and finally the results are displayed on the data processor 1.

A real-time detection device for a laboratory block motion based on the feature point recognition proposed by the application adopts a remote-controlled digital camera to send the gray pixels and a block motion measurement algorithm realized in the digital signal processing system based on the field programmable gate array to analyze the gray pixels to measure the motion of laboratory blocks. The block motion measurement algorithm constructs the Gaussian pyramid, and the sizes of the images in different groups are all the same; a difference is that template sizes of box filters used in different groups gradually increase, and the images of the same group in different layers use filters with the same size, but scale space factors of the filters gradually increase, so as to achieve a scale invariance; the block motion measurement algorithm rotates the image to the main direction before generating a feature descriptor, so as to ensure that the descriptor generated by one feature point uses information of the same image, realize a rotation invariance, and realize a better effect on a scale change when an illumination, a shadow and a focus are lost. Finally, a hardware implementation is performed on the block motion measurement algorithm in the field programmable gate array, so that a requirement of the system for a computing power is greatly reduced, the displacement of the block in the image before and after the test is calculated in real time, and a response speed is fast. In addition, the detection device for the laboratory block motion has advantages of a low manufacturing cost, a convenient installation, a difficulty in damage and a low maintenance cost.

The above is only a preferred embodiment of the application, and it is not intended to limit the application. Any modifications, equivalents, improvements, etc. made within a spirit and a principle of the application should be included in a scope of protection of the application.

What is claimed is:

1. A real-time detection method of a block motion based on a feature point recognition, comprising:
S1, calibrating a camera;
S2, shooting digital images of a block on a surface of a breakwater by the camera, and sending the digital images to a digital signal processing system based on a field programmable gate array;
S3, carrying out a feature point detection of the block in the images by the digital signal processing system;
S4, carrying out a coordinate conversion after the feature point detection;
S5, comparing position changes of the feature points of the block before and after a test, making a difference between coordinates of the two images before and after the test to obtain a change value of the feature points, and obtaining a displacement of the block; and
S6, displaying displacement calculation results on a data processor.

2. The real-time detection method of block motion based on feature point recognition according to claim 1, wherein the feature point detection in the S3 comprises:
S31, generating edge points of digital images by using a Hessian matrix, and setting each edge point in the digital images with the Hessian matrix;
S32, constructing a Gaussian pyramid by using the digital images;
S33, comparing a size of each pixel processed by the Hessian matrix with the size of the pixels in a three-dimensional neighborhood of the pixel; and if the pixel is a maximum value or a minimum value of the pixels in the neighborhood, reserving this pixel as a preliminary feature point;
S34, counting Harr wavelet features in the neighborhood of the feature point;
S35, generating feature point descriptors according to the Harr wavelet features;
S36: judging a matching degree of the two feature points by calculating a distance between the two feature points, and the shorter the distance between the two feature points, the higher the matching degree; and
S37: screening the feature points corresponding to each block, reserving the feature point with the highest matching degree to represent the block, and completing the feature point detection.

3. The real-time detection method of block motion based on feature point recognition according to claim 2, wherein a method of generating the edge points of the digital images by using the Hessian matrix used in the S31 is as follows:
$$H ( f ( x , y ) ) = [ \begin{matrix}\frac{{\partial }^{2} f}{\partial {x}^{2}} & \frac{{\partial }^{2} f}{\partial x \partial y} \\ \frac{{\partial }^{2} f}{\partial x \partial y} & \frac{{\partial }^{2} f}{\partial {y}^{2}}\end{matrix} ] ,$$
wherein f(x,y) is a pixel value of each image;
a discriminant of the Hessian matrix is:
$$det ( H ) = \frac{{\partial }^{2}}{\partial {x}^{2}} \frac{{\partial }^{2}}{\partial {y}^{2}} - ( \frac{{\partial }^{2} f}{\partial x \partial y} ) ;$$
when the discriminant of the Hessian matrix gets a local maximum, judging that the current point is brighter or darker than other points in the surrounding neighborhood, and then this point is a position of the feature point.

4. The real-time detection method of block motion based on feature point recognition according to claim 2, wherein in a Gaussian pyramid construction in the S32, sizes of the images are unchanged, only the size and a scale of a Gaussian fuzzy template are changed.

5. The real-time detection method of block motion based on feature point recognition according to claim 2, wherein steps of counting the Harr wavelet features in the neighborhood of the pixels in the S34 are as follows:
S341, taking one feature point as a center, calculating a sum of Haar wavelet responses of all the points in the neighborhood in a horizontal direction and a vertical direction;
S342, assigning Gaussian weight coefficients to Haar wavelet response values, making a response contribution near the feature point greater than the response contribution far from the feature point;
S343, adding the Haar wavelet responses in the neighborhood to form new vectors; and
S344, traversing a whole area and selecting a direction of the longest vector as a main direction of the feature point.

6. The real-time block motion detection method based on feature point recognition according to claim 2, wherein generating the feature point descriptors in the S35 is to take a 4*4 rectangular area block around the feature point along the main direction of the feature point, and count the Harr wavelet features of the pixels in each sub-area in the horizontal direction and the vertical direction; the Haar wavelet features include the sum of horizontal values, the sum of horizontal absolute values, the sum of vertical absolute values and the sum of vertical absolute values.

7. The real-time detection method of block motion based on feature point recognition according to claim 1, wherein a coordinate conversion method used in the S4 is as follows:
establishing an o₀uv pixel coordinate system, with o₀ as an origin of the pixel coordinate system, (u₀, v₀) as a pixel coordinate of a center of an image plane, establishing o₁xy as a physical coordinate system, with o₁ as the origin of the physical coordinate system;
$$u = \frac{x}{dx} + {u}_{0} ,$$
$$v = \frac{y}{dy} + {v}_{0} ,$$
wherein dx is a physical size of each pixel in a u-axis direction, and dy is the physical size of each pixel in a v-axis direction.

8. The real-time detection method of block motion based on feature point recognition according to claim 1, wherein a calibration of the camera in the S1 adopts a Zhang Zhengyou's calibration method.
